(19) United States
(12) Patent Application Publication
(10) Pub. No.: US 2025/0337561 A1
(43) Pub. Date: Oct. 30, 2025

(54) SYSTEM AND METHOD TO ACCELERATING FULLY HOMOMORPHIC ENCRYPTION

(71) Applicant: New York University, New York, NY (US)

(72) Inventors: Brandon Reagen, New York, NY (US); Austin Ebel, Brooklyn, NY (US)

(21) Appl. No.: 19/190,516

(22) Filed: Apr. 25, 2025

Related U.S. Application Data
(60) Provisional application No. 63/638,715, filed on Apr. 25, 2024.

(51) Int. Cl. H04L 9/00; H04L 9/08

(52) U.S. Cl. CPC H04L 9/008; H04L 9/088

(57) ABSTRACT

An exemplary homomorphic encryption-based system and method are disclosed using systolic computing hardware for each or a subset of major kernels used in a homomorphic encryption or fully homomorphic encryption operation, e.g., matrix-vector multiplication, modulus change, among others. The exemplary homomorphic encryption-based system and method can be used in a HE or FHE data flow for accelerated computation thereof, employing interleaved limb hardware implementations, as a data tiling technique, to create a common data input/output pattern across all kernels implemented in a 2D systolic array of processing elements to allow an intended portion of, or the entire, pipelined architecture to operate in lockstep, or near lockstep.

### RELATED APPLICATION

This U.S. application claims priority to, and the benefit of, U.S. Provisional Patent Application No. 63/638,715, filed Apr. 25, 2024, entitled “Osiris: A Systolic Approach to Accelerating Fully Homomorphic Encryption,” which is incorporated by reference herein in its entirety.

### STATEMENT REGARDING FEDERALLY SPONSORED RESEARCH OR DEVELOPMENT

This invention was made with government support under HR0011-21-9-0003, awarded by the Defense Advanced Research Projects Agency (DARPA). The government has certain rights in the invention.

### BACKGROUND

Homomorphic encryption and fully homomorphic encryption provide secure and privacy-preserving outsourced computation, e.g., in cloud computing, using encryption schemes that operates on encrypted data in its encrypted state, typically, without access to the encryption key and without decrypting the encrypted data to perform the operation. Homomorphic encryption can be applied on any data, e.g., financial, medical, or genomic data.

State of the art fully homomorphic encryption and other homomorphic encryption operation can introduce significant performance overhead and require significant computing resources to perform. Hardware acceleration architectures have been proposed that could provide the computational power needed to overcome the slowdown. Hardware acceleration and like operation are often described or defined in the context of a kernel.

Fixed-function ASICs do not provide the flexibility to support a variety of FHE workloads nor algorithms; vector-based operations can be flexible but often rely on complex circuitry for generality and performance (e.g., register files and chaining); tiled/clustered may be difficult to program and require large network-on-chips (NoCs).

There is a benefit to improving computing hardware design for homomorphic encryption and like classes of computations.

### SUMMARY

An exemplary homomorphic encryption-based accelerator/co-processing system and method are disclosed using systolic computing hardware for major kernels and operations used in a homomorphic encryption or fully homomorphic encryption operation. The exemplary homomorphic encryption-based system and method employs systolic computing hardware architectures that can facilitate straightforward hardware implementations, clear compute-memory tradeoffs facilitating straightforward analytical analysis, and elimination of complex hardware structures (e.g., register files). The exemplary homomorphic encryption-based system and method can be used in a HE or FHE data flow for accelerated computation thereof, employing interleaved limb hardware implementations, as a data tiling technique, to create a common data input/output pattern across all kernels implemented in a 2D systolic array of processing elements to allow an intended portion of, or the entire, pipelined architecture to operate in lockstep, or near lockstep. Connecting processing units or elements can be technically challenging, e.g., due to the different data access and computational patterns of the kernel, though doing so can provide great benefit in terms of speed, resources, and processing time, among others.

An exemplary homomorphic encryption-based system and method may be used for processing key-switches, bootstrapping, and full neural network inferences, among other applications, with high utilization of the hardware across a range of HE or FHE parameters. The exemplary homomorphic encryption-based system and method may implement a giant-step centric (GSC) dataflow that efficiently executes, e.g., via optimized rerun and parallelism, state-of-the-art FHE matrix-vector product algorithms onto the accelerated hardware.

Examples of FHE operators that can be offloaded onto the exemplary hardware include, but are not limited to, matrix-vector product and matrix-matrix product computation, e.g., via an algorithm (e.g., BSGS algorithm) or via an operator (e.g., modulus change operator, hoist operation, on-the-fly limb extension operator, Basis conversion operator, number theoretic transform, inverse number theoretic transform, among others). The operations can be used in the context of HE/FHE algorithms, e.g., CKKS, BGV, BFV, among others.

In an aspect, a processor (e.g., microprocessor, ASIC, co-processor) is disclosed comprising a 2D systolic array circuit (circuit includes PEs+limbs) configured to perform a homomorphic encryption kernel operation (e.g., FHE, e.g., Basis Conversion (BConv)), the 2D systolic array circuit comprising: an array of n×m processing elements (PEs), a subset of which are the same as one another, wherein processing elements of the array of n×m processing elements are configured to run in lock-step to one another and at least one connected first input limb and second input limb; a first set of interleaved pipelined input, as the first input limb, (e.g., Multi-Delay Commutator) coupled to the array of n×m processing elements at a first set of inputs to the array; and a second set of interleaved pipelined input, as the second input limb, coupled to the array of n×m processing elements at a second set of inputs to the array, wherein data corresponding to mathematical elements of a mathematical equation to perform the homomorphic encryption kernel operation are directed through the first set of interleaved pipelined input in an interleaved and lock-step manner for computation by the processing elements of the array and limbs in lockstep execution for the homomorphic encryption kernel operation.

In some embodiments, the 2D systolic array circuit is configured to perform, at least, matrix-matrix multiplication (e.g., switch-modulus multiply-accumulate operation), for a Basis Conversion (BConv) operation, the array of n×m processing elements of the 2D systolic array circuit, as an array of cells, includes a first row of cells configured to receive, as a sequence of first inputs, the first set of interleaved limbs (L₁, L₂, . . . , Lₙ), each of which is represented by a corresponding set of coefficients and each of which is associated with a modulus (q₁, q₂, . . . , qₙ), wherein the first set of interleaved limbs (L₁, L₂, . . . , Lₙ) is derived from a first polynomial representing a first value at a first modulus, and wherein the array of cells includes a first column of cells configured to receive, as a sequence of second inputs, base table constants.

In some embodiments, each cell of the array is configured to perform (1) a SwitchModulus function to convert a value under an old modulus to a new modulus, (2) a multiply function, and (3) an accumulate function) (e.g., wherein the array of cells includes a last rows of cells configured to provide, as a sequence of outputs a second set of interleaved limbs (L₁′L₂′, . . . , L_{z}′), each of which is represented by a corresponding set of coefficients and each of which is associated with a modulus (q1′, q2′, qz′), wherein the second set of interleaved limbs (L₁′, L₂′, . . . , L_{z}′) represents a second polynomial representing a second value at a second modulus, and wherein the second value at the second modulus is equivalent to the first value at the first modulus).

In some embodiments, the first set of interleaved pipelined input is configured to perform interleaved Inverse Number Theoretic Transform(INTT) operations.

In some embodiments, the 2D systolic array circuit includes a set of interleaved pipelined output, as the first output limb, wherein the first set of interleaved pipelined output is configured to perform Number Theoretic Transform (NTT) operations.

In some embodiments, the first set of interleaved pipelined input comprises a plurality of multi-delay elements (e.g., multi-delay commutators) arranged in parallel configuration having s stages and p parallel inputs (e.g., wherein the number of p parallel inputs corresponds to a number of array size of the n×m processing elements).

In some embodiments, the processor further includes an automorphism unit having inputs coupled with outputs of an interleaved pipelined output (e.g., performing NTT).

In some embodiments, the processor further includes a first Hadamard unit coupled to the first set of interleaved pipelined input.

In some embodiments, the processor further includes a second Hadamard unit coupled to the first set of interleaved pipelined output.

In some embodiments, the lockstep execution includes, at least, operation of the array of n×m processing elements, the first set of interleaved pipelined input, and the second set of interleaved pipelined input under a common clock signal (e.g., such that each accepts an input and produces an output in a single clock cycle (e.g., the components being rate-matched).

In some embodiments, each cell of the array is configured to perform a switch-modulus multiply-accumulate operation

In some embodiments, the processor further includes a controller configured to write the mathematical elements of the mathematical equation to perform the homomorphic encryption kernel operation to memory, the memory being operatively accessible to the first set of interleaved pipelined input and the second set of interleaved pipelined input.

In some embodiments, the processor further includes a controller configured to perform a giant-step centric (GSC) dataflow operator to perform an HE or FHE operation.

In some embodiments, the homomorphic encryption kernel operation includes at least one of: modulus change, CKKS, BGV, BFV, addition and/or multiplications of two ciphertexts, additions and/or multiplications of a ciphertext and a plaintext polynomial, rotation of a cleartext and/or ciphertext.

In another aspect, a method is disclosed comprising receiving an encrypted message; and providing the encrypted message to any one of the above-noted processors (e.g., comprising the 2D systolic array circuit) to perform an HE or FHE operation on the encrypted message (without decryption of the encrypted message).

The method includes (i) performing a homomorphic encryption kernel operation using a 2D systolic array circuit comprising: an array of n×m processing elements (PEs), a subset of which are the same as one another, wherein processing elements of the array of n×m processing elements are configured to run in lock-step to one another and at least one connected first input limb and second input limb; a first set of interleaved pipelined input, as the first input limb, (e.g., Multi-Delay Commutator) coupled to the array of n×m processing elements at a first set of inputs to the array; and a second set of interleaved pipelined input, as the second input limb, coupled to the array of n×m processing elements at a second set of inputs to the array; and (ii) directing data through the first set of interleaved pipelined input in an interleaved and lock-step manner for computation by the processing elements of the array and limbs in lockstep execution for the homomorphic encryption kernel operation.

In some embodiments, the method includes reconfiguring the first set of interleaved pipelined input to operate as an interleaved pipelined hardware output for a subset of the processing.

In some embodiments, the method includes writing the mathematical elements of the mathematical equation to perform the homomorphic encryption kernel operation to memory, the memory being operatively accessible to the first set of interleaved pipelined input and the second set of interleaved pipelined input.

In another aspect, a non-transitory computer-readable method is disclosed comprising instructions that, when executed by a host processor or logic circuit, causes the host processor or logic circuit to: receive an encrypted message; and provide the encrypted message to the processor (e.g., comprising the 2D systolic array circuit) to perform an HE or FHE operation to the encrypted message (without decryption of the encrypted message).

### BRIEF DESCRIPTION OF DRAWINGS

FIG. 1 shows a processor having a 2D systolic array circuit for performing a homomorphic encryption-based kernel operation in accordance with an illustrative embodiment.

FIG. 2 shows an example computing architecture implementation for a 2D systolic array circuit and interleaved limbs, e.g., as described in relation to FIG. 1, in accordance with an illustrative embodiment.

FIGS. 3A-3E shows an example implementation and method of operation for the 2D systolic array circuit and interleaved limbs of FIGS. 1 and 2 in executing a HE/FHE operation in accordance with an illustrative embodiment.

FIGS. 4A-4F show an example implementation and method of operation for the 2D systolic array circuit and interleaved limbs of FIGS. 1 and 2 in executing another HE/FHE operation using the same hardware in accordance with an illustrative embodiment.

FIGS. 5A-5C show experimental results from a study conducted to develop and evaluate the 2D systolic array circuit and interleaved limbs of FIGS. 1 and 2 in accordance with an illustrative embodiment.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

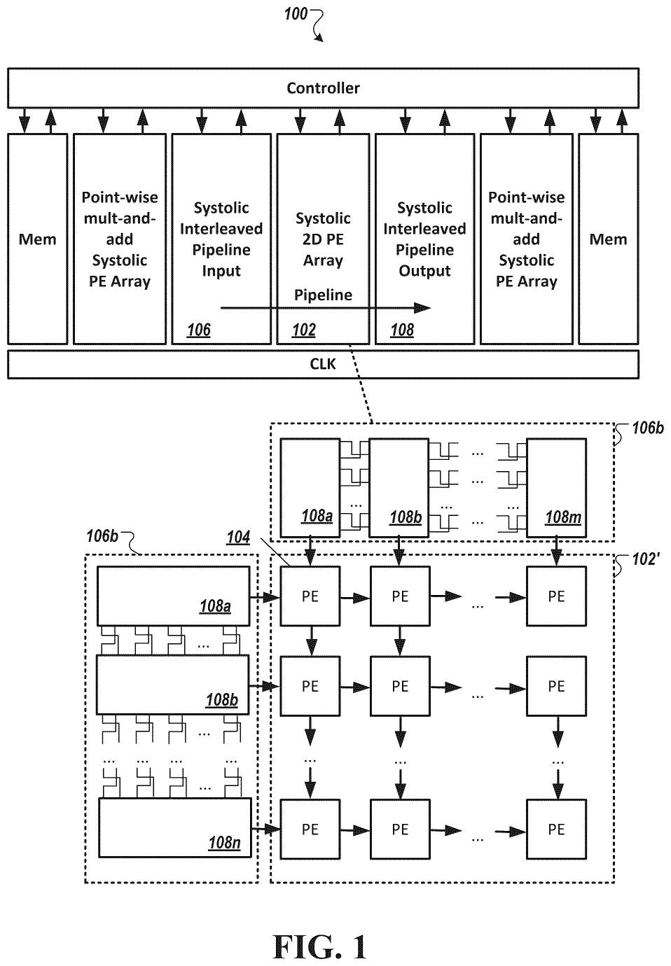

FIG. 1 shows a processor 100 having a 2D systolic array circuit 102 for performing a homomorphic encryption-based kernel operation (also referred to herein as a HE/FHE operation or operator) in accordance with an illustrative embodiment. The processor 100 can be a microprocessor, an ASIC, a co-processor for performing a HE, or FHE, operation on an encrypted message (without decryption of the encrypted message).

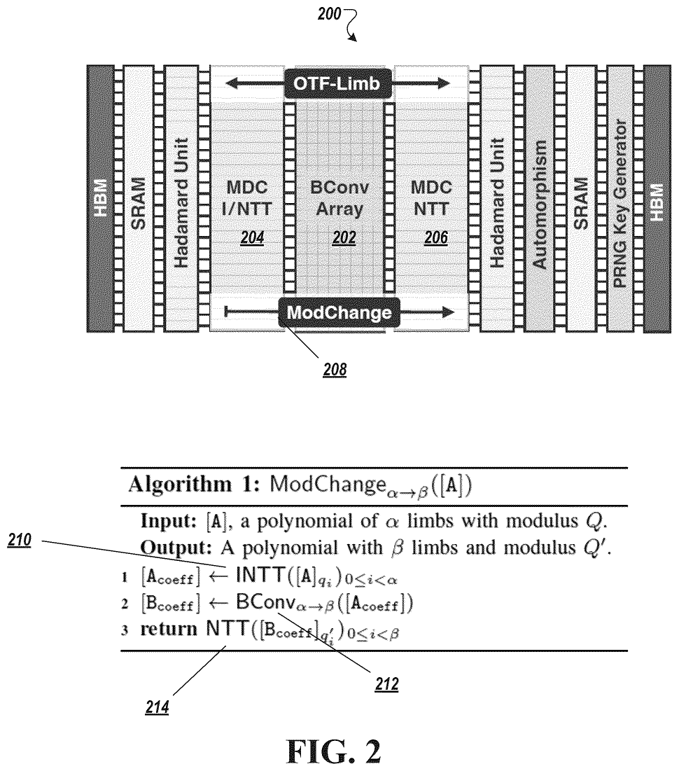

In the example shown in FIG. 1, the 2D systolic array circuit (shown as 102′) includes an array of processing elements (PEs) 104 that are connected to interleaved pipelined limb (shown as interleaved pipelined inputs 106a, 106b) to perform, e.g., a matrix-matrix multiplication. A distinction between the exemplary systolic computing hardware and current state-of-the-art fully homomorphic encryption (FHE) accelerators is that separate kernel units are dedicated to each step of a HE/FHE operator, such as the ModChange (INTT→BConv→NTT) routine described in relation to FIG. 2 (e.g., Algorithm 1) that can change the Residue Number System (RNS) representation of a modulus from a limbs to β limbs. Interleaved limbs of the exemplary hardware of FIG. 1 can resolve the differences between the desired input order of inverse number theoretic transform (I/NTT) and basis conversion BConv units and can enable the kernel units to operate together in lockstep. Therefore, when mapped onto the exemplary hardware, the HE/FHE operator, such as the ModChange operation described herein and other operators, can be viewed as a single macro-pipeline with a throughput of one output limb every N/p cycles.

In FIG. 1, each interleaved pipelined input 106a,106b includes a set of limbs 108 (shown as 108a, 108b, . . . 108n and 108a, 108b, . . . 108m) corresponding to the size (e.g., n×m) of the 2D systolic array circuit 102. Other operations can be performed using the noted hardware, e.g., matrix-vector multiplication, vector-matrix multiplication, matrix-scalar multiplication, scalar-matrix multiplication, among others described or referenced herein, and their equivalents. In one example, the matrix-matrix multiplication can be performed to provide a Basis Conversion, e.g., for the ModChange operator.

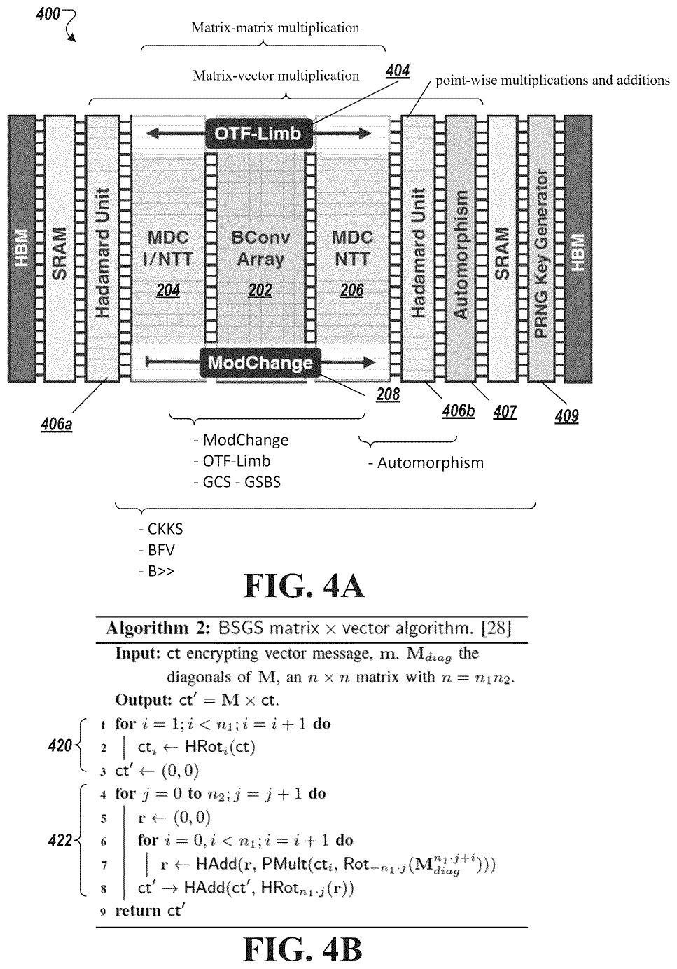

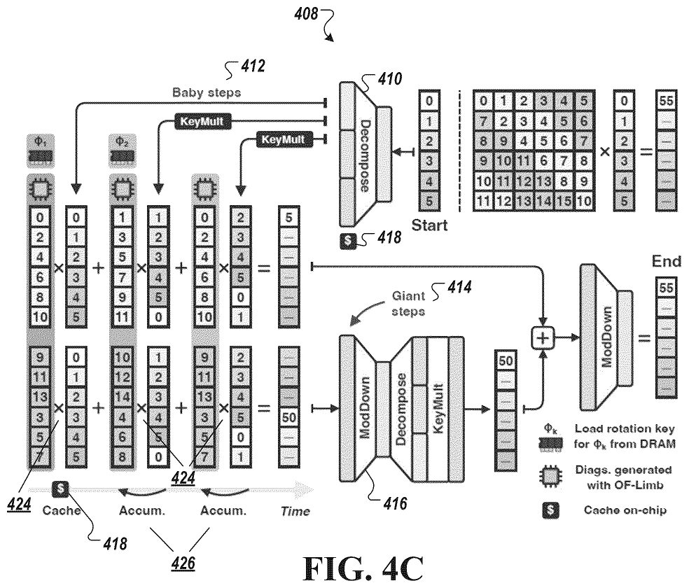

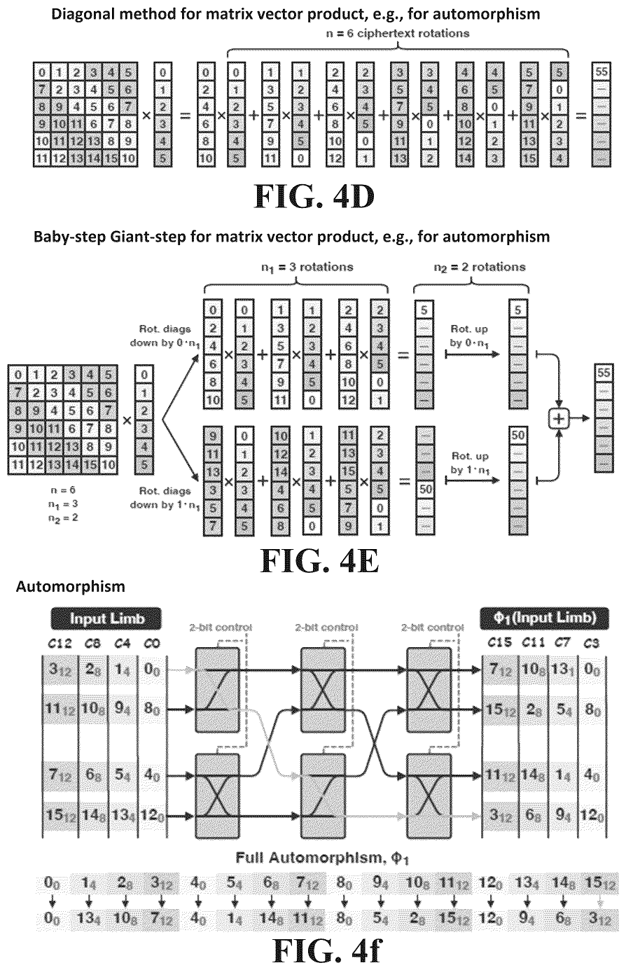

Referring still to FIG. 1, the n×m processing elements 104 are shown for the array 102. The 2D systolic array circuit 102 is a scalable architecture where each of the n×m processing elements 104 is configured with the same processing circuitry, or a subset (substantial portion) of them is the same. The two sets of interleaved pipelined inputs 106a, 106b, as the first and second input limbs, are coupled to the array of n×m processing elements at a first and second set of inputs to the array. Notably, the 2D systolic array circuit 102 and interleaved pipelined limbs 106a, 106b are configured to operate in lock-step (rate matched) to one another. That is, the individual processing elements 110 (not shown, see FIGS. 2, 4A, 4B, among others) of the interleaved pipelined limbs 106a, 106b are configured to under a common clock signal (e.g., global CLK) such that each accepts an input and produces an output within the same number of clock cycles (e.g., a single clock cycle).

In some embodiments, the processing elements 104 of the 2D systolic array circuit 102 include a switch-modulus multiply-accumulate circuit. Other equivalent circuits or functional circuits may be used. In some embodiments, the processing elements 110 of the interleaved pipelined limbs 106a, 106b are implemented as commutators to form a parallel multi-delay commutator, e.g., having interleaving connections to one another.

Data corresponding to mathematical elements of a mathematical equation for a homomorphic encryption kernel operation are thus directed through at least one of interleaved pipelined input in an interleaved and lock-step manner for computation by the processing elements 104, 110 of the array 102 and limbs 106 in lockstep execution for the homomorphic encryption kernel operation. In some embodiments, the 2D systolic array circuit 102 is configured to perform, at least, matrix-matrix multiplication.

In FIG. 1, the first set of interleaved pipelined input may include a plurality of multi-delay elements (e.g., multi-delay commutators) arranged in a parallel configuration having s stages and p parallel inputs (e.g., wherein the number of p parallel inputs corresponds to a number of array size of the n×m processing elements).

The first and second sets of interleaved pipelined input 106, 108 may be performing interleaved Inverse Number Theoretic Transform (INTT) operations, a time-consuming step in homomorphic schemes in ring polynomial multiplication (RPM). Number Theory Transform (NTT) and Karatsuba algorithms are efficient to accelerate RPM, yet they are limited by the modulus operations and degrees of the polynomial. The exemplary 2D systolic array circuit 102 and interleaved pipelined hardware (e.g., 106, 108), as hardware-accelerated hardware, can provide improvements to computing technology via accelerating computation for homomorphic schemes. In some embodiments, the 2D systolic array circuit includes a set of interleaved pipelined outputs, as the output limbs. The interleaved pipelined output may be configured to perform Number Theoretic Transform (NTT) operations.

In FIG. 1, the processor 100 includes a controller 109 configured to write the mathematical elements of the mathematical equation to perform the homomorphic encryption kernel operation to a memory, the memory being operatively accessible to the first set of interleaved pipelined input and the second set of interleaved pipelined input. The controller 109 is also operatively connected to the array 102 and limbs 106 and other components (e.g., Hadamard units, PRNG key generator, Automorphism units, among other circuits described herein).

### Example HE/FHE Algorithm #1 (CKKS and ModChange)

The exemplary systolic computing hardware of FIG. 1 may be employed to perform hardware-based accelerated computation for HE/FHE algorithms. Non-limiting examples can include the Cheon-Kim-Kim-Song (CKKS) method [14], the Brakerski-Gentry-Vaikuntanathan (BGV) method [10], and the Brakerski-Fan-Vercauteren (BFV) method [11], among others described or referenced herein. These algorithms can invoke operations involving the addition of two ciphertexts, the multiplication of two ciphertexts, the addition of a ciphertext and a plaintext polynomial, the multiplication of a ciphertext and a plaintext polynomial, the rotation of a cleartext or a ciphertext, among others.

Table 1 shows the notations of the parameters for a homomorphic encryption method for the CKKS method [14], as an illustrative non-limiting example. CKKS method can support homomorphic operations on and between plaintext polynomials and ciphertexts, similar to the BGV method [10] and BFV method [11].

TABLE 1

| Parameter | Description |
|---|---|
| m | Message, a vector of real or complex numbers. |
| [P] | Plaintext polynomial encoding the message, m. |
| [[C]] | Ciphertext encrypting the plaintext polynomial, [P]. |
| N | Power-of-two polynomial ring degree. |
| n | Length (slots) of the vector message, n ≤ N/2 (or N). |
| L | Maximum multiplicative level of [[C]]. |
| [symbol] | Current multiplicative level. |
| Q | Initial polynomial modulus. |
| qᵢ | Small moduli in residue numeral system (RNS) |
| | decomposition of Q = Πᵢ₌₀^{L} qᵢ. |
| α | Limbs in hybrid decomposition basis of Q. |
| dnum | Decomposition number in key-switching, ┌( [symbol] + 1)/α┐. |
| P | Auxiliary modulus used in key-switching. |
| pᵢ | Small moduli in RNS decomposition of P = Πᵢ₌₀^{α-1} pᵢ. |
| L_{boot} | Number of levels consumed by bootstrapping. |
| L_{eff} | Maximum achievable level after bootstrapping. |

In the CKKS method, the addition HAdd operation of two ciphertexts, the multiplication HMult of two ciphertexts, and the rotation HRot operation of a ciphertext, each can be performed on a vector message m by first encoding the vector into a cyclotomic polynomial [P], with coefficients modulo Q, and ring degree N, e.g., per Equation 1.

$$[ P ] = {Z}_{Q} [ X ] / ( {X}^{N} + 1 ) \qquad ( Eq . 1 )$$

The ciphertext [[C]] can be a pair of polynomials that can be generate rom a plaintext polynomial [P] encoding a message m as a vector of real or complex numbers. The ciphertext [[C]] can be made secure by adding a small amount of random noise to one of the polynomials. Since a polynomial modulus Q can be large (e.g., on the order of thousands of bits), it is often most efficient to decompose the polynomial modulus into many separate polynomial modulus, or limbs, each with a smaller size modulus, qᵢ, as shown in Equation 2, e.g., using the Chinese remainder theorem [13].

$$Q = {\prod }_{i = 0}^{L} {q}_{i} \qquad ( Eq . 2 )$$

In Equation 2, L sets the ciphertext's maximum multiplication level of the ciphertext [[C]], and operations such as HMult consume levels. When the current multiplicative level is zero, [symbol] =0, a Bootstrap procedure is often employed to increase the ciphertext's level to enable further computation. Bootstrapping consumes a fixed number of levels L_{boot} and therefore, a ciphertext [[C]] can only reach an effective level L_{eff} per Equation 3 after bootstrapping.

$${L}_{eff} = L - {L}_{boot} \qquad ( Eq . 3 )$$

Both the HMult and HRot operations can transform a ciphertext [[C]] initially decrypted by a secret key s into a ciphertext [[C]] only decryptable by a new secret key s′. To return to the secret key s and enable further computation, the ciphertext can be multiplied by a special switching key swk to perform a re-encryption of the ciphertext [[C}] under the old secret key s. However, a naïve multiplication with the switching key swk can add large noise.

Techniques described in [23] and [29] can address this issue directly by first using a Decompose operator to decompose the ciphertext [[C]] into many digits and performing a KeyMult operation at a higher modulus. Changing a ciphertext's modulus can be expensive, e.g., employing a ModChange operation that requires many Inverse Number Theoretic Transforms (INTTs), Number Theoretic Transforms (NTTs), and basis conversion BConv operations.

ModChange. Algorithm 1 (FIG. 2) describes a HE/FHE ModChange operation 208 that can be performed by the exemplary computing architecture (FIG. 2) to change the Residue Number System (RNS) representation of a modulus from α limbs to β limbs. When α<β, the conversion operation BConv can be referred to as ModUp, and when α>β, the BConv can be referred to as ModDown. A Rescale operation can be a specific case of ModDown when β=α−1.

In Algorithm 1 (of FIG. 2), separate Inverse Number Theoretic Transforms (I/NTTs) can be applied to each limb, and the modulus Q can change per Equation 4 to change modulus Q′ per Equation 5.

$$Q = {\prod }_{i = 0}^{α - 1} {q}_{i} \qquad ( Eq . 4 )$$

$${Q}^{′} = {\prod }_{i = 0}^{β - 1} {q}_{i}^{′} \qquad ( Eq . 5 )$$

The core operation in a BConv operation can be a matrix-matrix multiplication between a base table of scaling factors and an input polynomial. This matrix multiplication can be accelerated using the 2D systolic array and interleaved limb as described in relation to FIG. 1.

### Example Computing Architecture

FIG. 2 shows an example computing architecture implementation 200 for a 2D systolic array circuit (e.g., 102) and interleaved limbs (e.g., 106, 108), e.g., as described in relation to FIG. 1, in accordance with an illustrative embodiment. In FIG. 2, the computing architecture includes a BConv array kernel 202, a Multi-Delay-Commutator (MDC) I/NTT kernel 204, and an MCC NTT kernel 206 that can implement the exemplary 2D systolic array circuit 102 and interleaved pipelined hardware (e.g., 106, 108) of FIG. 1.

Accelerated 1/NTT with Multi-Delay Commutator: To accelerate the Inverse Number Theoretic Transform (I/NTT) kernel and the Number Theoretic Transform (NTT) kernel, the interleaved pipelined hardware (e.g., 106, 108) of FIG. 1 may be implemented as a pipelined Multi-Delay-Commutator (MDC) circuit, e.g., a radix-2 pipelined MDC. The interleaved pipelined hardware (e.g., 106, 108), as an MDC, may be defined by two parameters: (i) the number of stages s of MDC in the design, defining its depth, and (ii) the number of parallel inputs and outputs p to each stage, defining its width.

The Multi-Delay Commutator belongs to a family of pipelined architectures introduced in the 1970s to accelerate the Fast Fourier Transform (FFT) [25, 26]. Their simplicity has enabled successful VLSI implementation across a broad range of applications, from early radar infrastructure [39] to modern wireless communication systems [47].

The pipelined MDC (e.g., Radix-2 pipelined MDC) can perform the Cooley-Tukey FFT algorithm [16] to decompose an N-point DFT into log 2(N) stages, each containing N/2 butterfly operations. Each stage in the MDC can perform all the butterfly operations corresponding to the same stage in the Cooley-Tukey data flow. To this end, any radix-2 MDC can have s=log₂(N) stages. The p-parallel MDC can comprise p/2 butterfly cells per stage, where each cell accepts two inputs and performs one butterfly operation per cycle. In the Cooley-Tukey data flow, the width of each butterfly (i.e., the difference in coefficient indices between inputs) can vary from stage to stage. The MDC can achieve this same variability through a series of fixed buffers and multiplexers placed between each stage to commute the order of inputs. In total, each MDC has N−p buffers.

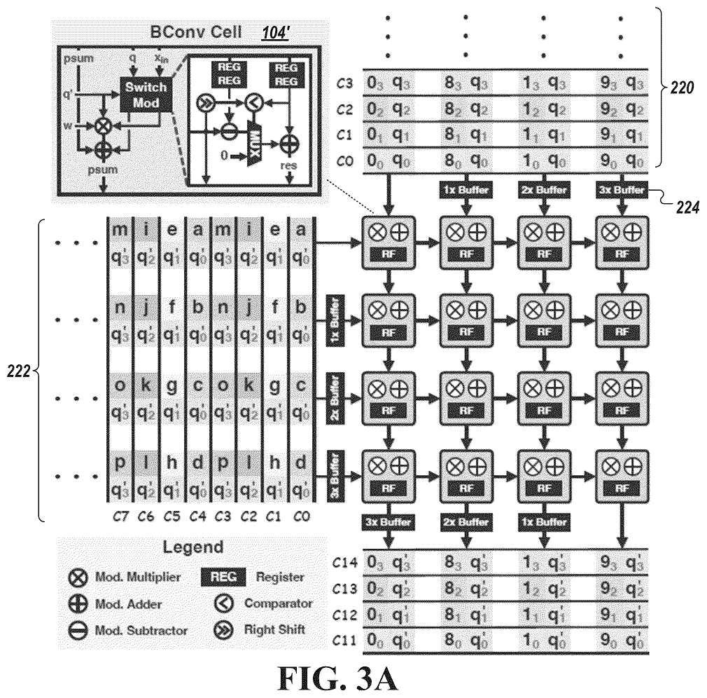

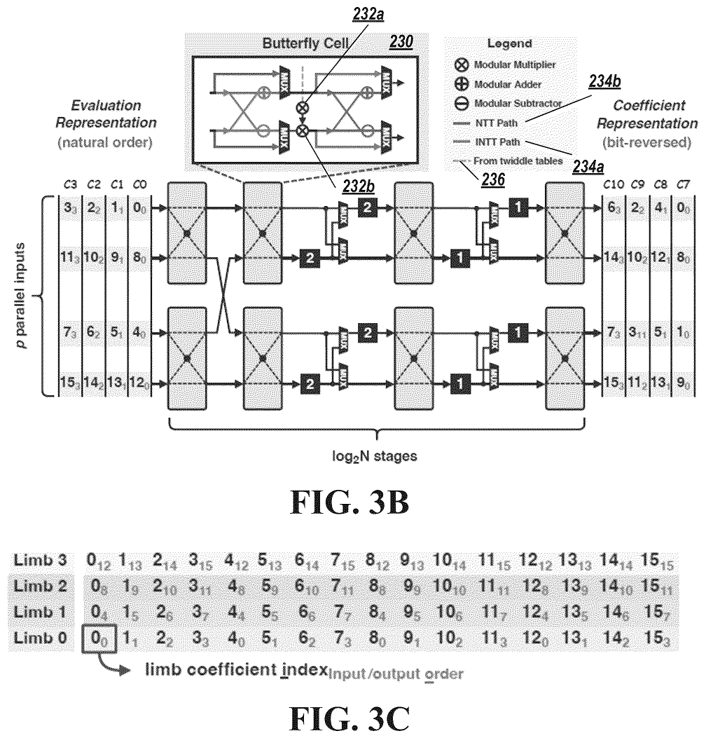

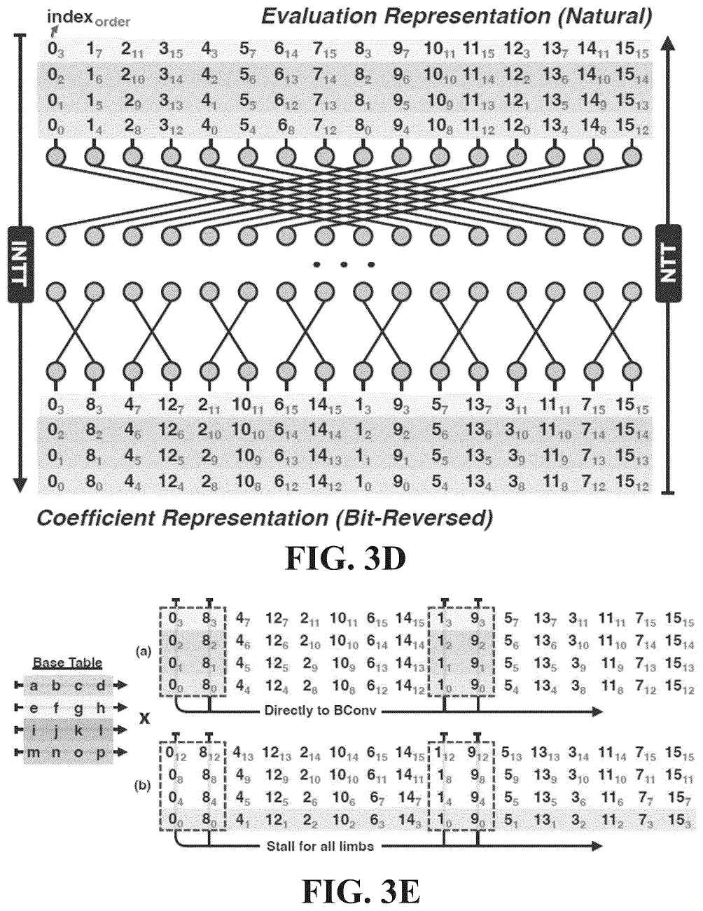

Improvement Discussion. FIG. 3B shows a 4-parallel MDC module performing the INTT on the first limb of the example polynomial shown in FIG. 3C. The parallel MDC module of FIG. 3B has three noted features.

First, each butterfly cell 230 contains two modular multipliers, one (232a) for on-the-fly twiddle factor generation (OTF-Twiddle) [34] and another (232b) for the butterfly operation itself. OTF-Twiddle (shown via path 236) can decompose N unique twiddle factors into two tables of size \sqrt{n}, facilitating the generation of any twiddle factor by multiplying two entries, one from each table. The decomposition can reduce the storage requirement of twiddle factors in the exemplary system from 16 MiB to 0.24 MiB, with groups of 16 lanes sharing a set of twiddle tables.

Second, the pipelined FFT modules (e.g., via the MDC) can operate bi-directionally: data flowing in one direction computes the FFT while the other direction performs the inverse FFT, which can double the throughput of the DiagMult kernel. The bi-directionality can be shown via each butterfly cell featuring both INTT and NTT paths (234a, 234b). Control logic (not shown) may be implemented between stages that route both directions, e.g., as described in [37].

Third, the MDC can accept and produce p elements per cycle to provide a constant flow of data that can simplify rate-matching.

Interleaving 1/NTTs with Multi-Delay Commutator: The pipelined MDC can interleave the computations of independent I/NTTs. Recall from Algorithm 1 (FIG. 2) that the I/NTT kernel (204) can occur in the ModChange kernel (208) as part of the INTT→BConv→NTT routine (210, 212, 214); non-optimized configurations can cause stalls. Because each I/NTT (210) can act on unique rows, as limbs, of the matrix representation, e.g., as described in relation to FIG. 3C, and because the BConv operation (212) is a matrix multiplication, wherein rows of a base table can be multiplied with columns of an input polynomial, each column in the input polynomial can contain coefficients from all its limbs. To this end, performing INTTs (210) on each limb sequentially can stall the ModChange pipeline until all limbs have been processed.

To avoid stalls, the pipelined MDC can be configured to have the output order of the MDC INTT (204) match the column-wise input order required by the BConv kernel (202). FIG. 3D shows an example interleaved I/NTT format using the iₒ notation and the 4-parallel MDC. As shown in the example of FIG. 3D, while the INTT input indices are identical to those in FIG. 3C, the subscripts are different. Specifically, the p=4 values can be fed from the first limb to the example MDC INTT unit (204). In the next cycle, rather than the next four values from the first limb, the first four values can be fed from the second limb to the 4-parallel MDC, beginning a second INTT. The interleaving process can be continued for all limbs in the polynomial before returning to the first limb for its second set of four values. As a result, coefficients flow from the MDC INTT (204) in the column-wise order required by the BConv kernel (202), facilitating the two units to operate together in lockstep.

Improvement Discussion. FIG. 3E shows the differences in INTT output (BConv input) ordering between the exemplary system and current state-of-the-art FHE accelerators. As shown, the BConv kernel (202) in the exemplary system can begin before any single INTT completes. This change to data flow can be achieved by extending the buffers between each MDC stage by a factor equal to the number of interleaved limbs, compensating for the increased delay between butterflies of the same I/NTT. One example implementation can support a maximum of 32 interleaved limbs, so a 256-parallel MDC unit can have 16 MiB of buffers.

Accelerating BConv Kernel using 2D Systolic Arrays: To accelerate the BConv kernel (202), the 2D systolic array (102) can be implemented to provide large matrix-matrix multiplication as the core operation of the BConv kernel. In the 2D systolic array (102), inputs flow through the processing elements (PEs) in a pipelined fashion. For matrix multiplication, each PE can perform one multiply-accumulate (MAC) operation per cycle, contributing to a partial sum passed between neighboring PEs. Then, outputs can be generated as a stream from the processing elements at the periphery of the array. When the array's dimensions are smaller than the dimensions of the input matrices, blocked matrix multiplication algorithms can be required.

Improvement Discussion. The BConv kernel (202) can be accelerated with a large 2D input-stationary systolic array where the height of the systolic array can be determined by the largest number of limbs of any input polynomial passed to the BConv kernel. In hybrid key-switching, all BConv operations can act on input polynomials of at most a limbs, either as the size of each decomposed digit in ModUp or as the number of limbs in the auxiliary modulus P in ModDown (Table 1). The number of limbs in decomposition can be set to 8 (i.e., α=8) to minimize the size of key-switching keys while remaining 128-bit secure. The height of the systolic array (102) can also be sized to 8 PEs tall. Likewise, the BConv array can be sized to be 256 PEs wide to accept the MDC's output of p=256 coefficients per cycle. As a result, the MDC (204) can partition the larger α×N input polynomial into smaller blocks, each of size α×p, that can then be fed to the systolic array (102).

FIG. 3A shows an example 4×4 BConv systolic array (102) processing the interleaved polynomial shown in FIG. 3D, with N=16 and [symbol] =3. For consistency, FIG. 3E uses the same base table, converting an input polynomial from modulus Q=Π_{i≤3} qᵢ to a new modulus Q′=Π_{i≤3} q′ᵢ. The 2D systolic array (102) has four noted features.

First, interleaved coefficients (top) (220) and base table constants (left) (222) can be first skewed by buffers 224 of differing lengths before entering the array. Skewed input matrices of the systolic arrays (102) can ensure that the correct partial sums psums are accumulated within the array.

Second, input polynomial coefficients may be double-buffered. Two registers within each PE 104 (shown as 104′) may be reserved for input coefficients: one for the coefficient from the current α×p (4×4 in FIG. 3A) block being processed and another for preloading coefficients from the next block.

Third, all PEs (104) can perform the same switch-modulus multiply-accumulate (SMAC) operation. For a base table constant w, an input coefficient xᵢₙ, and an old (new) modulus q (q′), this operation can be defined per Equation 6.

$$psum ← psum + w \cdot {SwitchModulus}_{q \to {q}^{′}} ( {x}_{in} ) ( mod {q}^{′} ) \qquad ( Eq . 6 )$$

In Equation 6, since the SwitchModulus function can involve both the old modulus, q, and the new modulus, q′, each q′ᵢ can be streamed alongside its corresponding row of base table constants so that all partial sums can be accumulated under the same new modulus. Finally, output coefficients leave the array interleaved and are unskewed by a set of complementary buffers. Since the BConv kernel (202) is a part of the larger ModChange pipeline, keeping coefficients interleaved ensures that they can be passed directly to subsequent MDC NTT hardware 206.

Indeed, in one example, the 2D systolic array circuit 102 and interleaving pipelined inputs 106 are configured to perform a SwitchModulus function to convert a value under an old modulus to a new modulus. The same circuitry can be employed for other multiply function, accumulate function, or a combination thereof, among others. For the example, e.g., switch-modulus multiply-accumulate operation, for a Basis Conversion (BConv) operation, the array of n×m processing elements of the 2D systolic array circuit, as an array of cells, includes a first row of cells configured to receive, as a sequence of first inputs, the first set of interleaved limbs (L₁, L₂, . . . , Lₙ), each of which is represented by a corresponding set of coefficients and each of which is associated with a modulus (q₁, q₂, . . . , qₙ), wherein the first set of interleaved limbs (L₁, L₂, . . . , Lₙ) is derived from a first polynomial representing a first value at a first modulus, and wherein the array of cells includes a first column of cells configured to receive, as a sequence of second inputs, base table constants. The array of cells may include a last rows of cells configured to provide, as a sequence of outputs a second set of interleaved limbs (L₁′, L₂′, . . . , L_{z}′), each of which is represented by a corresponding set of coefficients and each of which is associated with a modulus (q1′, q2′, qz′), where the second set of interleaved limbs (L₁′, L₂′, . . . , L_{z}′) represents a second polynomial representing a second value at a second modulus, and wherein the second value at the second modulus is equivalent to the first value at the first modulus).

Improvement discussion. Current state-of-the-art ARK [33] and SHARP [32] employ systolic arrays to accelerate BConv. These systems do not interleave limbs and have been observed to have problematic memory access patterns that appears to force the previous studies [33], [32] to allocate 1024 1×6 (ARK) or 2×8 (SHARP) output-stationary systolic arrays, one per lane, broadcasting unique base table constants across the 256 lanes in each cluster using central broadcast units (BrUs). In contrast, the interleaved ordering in the 2D systolic array kernel 202 facilitates base table constants to be passed between PEs in one large 2D array.

Kernel Accelerator. FIG. 3A illustrates an example 4×16 matrix representation for a polynomial with ring degree N=16 and multiplicative level [symbol] =3 (four limbs), wherein each element is denoted as iₒ. The index i represents the position of the coefficient within its limb. In FIG. 3A, the polynomial is shown in natural order, with indices increasing from left to right. The same polynomial can also be represented in bit-reversed order, which can be distinguished by visualizing only its reordered indices. The subscript, o, indicates the order in which coefficients enter or leave a hardware component of the exemplary system. For example, the element in FIG. 3D conveys that the first coefficient of the first limb is in the initial set of four values to enter or leave a component.

The order coefficients enter and leave functional units in the 2D systolic array 202 differ from current state-of-the-art FHE accelerators. Interleaving the computations of separate limbs can facilitate the lockstep execution of larger FHE kernels (e.g., ModChange), so explicitly writing each coefficient in a polynomial as iₒ can show better comparisons between the data flow of the exemplary system with current state-of-the-art systems.

### Example HE/FHE Algorithm #2 (Matrix-Vector Multiplication)

FIG. 4A shows additional HE/FHE operations that may be performed using the exemplary systolic computing hardware, including matrix-vector multiplication using the Baby-step giant-step (BSGS) algorithm and hoisting. Matrix-vector products can account for 70% to 99% of the private inference latency in FHE [22]. Therefore, the exemplary system's implementation and mapping strategies are tailored to the hoisting method and associated algorithms. The exemplary systolic computing hardware is the first ASIC system to employ the hoisting method [9], [28] for matrix-vector products. The BSGS algorithm can execute the OTF-Limb operator 404.

Baby-Step Giant-Step: (ii) Baby-step giant-step (BSGS) is an optimized method to implement the FHE matrix-vector products. The baby-step giant-step (BSGS) method (as a homomorphic matrix-vector operator) can reduce the runtime complexity of homomorphic matrix-vector products to O(\sqrt{n}) [28](as compared O(n) performed by naïve techniques such as the diagonal method). To this end, as the number of non-zero diagonals increases, so does the impact of this optimization.

FIG. 4B show an example Algorithm 2 for executing the BSGS matrix-vector operation. In FIG. 4B, matrix-vector products are parameterized by two constants: the number n₁ of baby steps or input rotations, and the number n₂ of giant steps or partial product rotations, where n₁n₂=n (e.g., n₁=3 and n₂=2 such that n₁n₂=6). The distinction between n₁ and n₂ lies in the magnitude of their rotations and when the rotations are performed. The n₁ input rotations (420) are first generated (baby steps) of the input ciphertext, and then each baby-step rotation is multiplied with n₂ diagonals (422). There are n₂ partial products left, each offset by some multiple of n₁. Therefore, n₂ partial rotations (giant steps) are required to realign ciphertexts before the final reduction. Rotations can be expensive, and the key feature of BSGS is that ciphertext rotations can be reused and instead rotate matrix diagonals. Since matrix diagonals are known as a priori (i.e., weights in convolutions or a constant matrix to bootstrapping), they can be rotated before being encoded, reducing the number of ciphertext rotations to just n₁+n₂, and rotations are minimized when n₁=n₂=V.

Hardware Accelerated Improvements. While a baby-step giant-step BSGS algorithm can reduce the number of ciphertext rotations in matrix-vector products of the exemplary systolic hardware, the BSGS algorithm does not reduce the number of plaintext diagonal multiplications. When the number of non-zero diagonals is large, a fraction of end-to-end latency comes from on-the-fly limb extension (OTF-Limb). To mitigate this bottleneck, the bi-directionality of the pipelined number theoretic transform (NTT) modules (204, 206) can be used to reverse the direction of the MDC INTT unit (204) for the duration of the OTF-Limb (404). Since the OTF-Limb (404) generates diagonals through repeated NTTs, the INTT unit (204) can be utilized and does not have to be left idle otherwise. This operation can double the throughput of OTF-Limb (404), and Hadamard units (406a, 406b) can be implemented on each side of the exemplary systolic computing hardware to generate and accumulate partial products.

Indeed, the architecture of the exemplary systolic computing hardware can also provide additional improved computing hardware design and operation, e.g., idle hardware component reuse.

On-the-fly limb extension (OTF-Limb) method 404 provides hardware acceleration [33] to improve arithmetic intensity. OTF-Limb can use a single precomputed limb (q₀) of the plaintext diagonal (coefficient representation) to generate all other limbs. The optimization can save off-chip communications at the cost of additional computation to generate them on-chip. Any i'th limb can be generated from this q₀-limb through Equation 7.

$${[ P ]}_{{q}_{i}} = NTT ( {[ {P}_{coeff} ]}_{{q}_{0}} ) mod {q}_{i} \qquad ( Eq . 7 )$$

To this end, OTF-Limb (404) can be performed with MDC units (204, 206) to generate all plaintext diagonals in the matrix-vector products in bootstrapping and in the linear and convolutional layers of neural networks.

Convolutions as Matrix-Vector Products: Convolution as a matrix-vector product can also be an optimized method specific to private neural network inference. With the exemplary systolic computing hardware, convolutions can be converted to their equivalent matrix-vector form to benefit from hoisting in all network layers. This can be done by adopting a Hybrid++ method, e.g., as described in [22].

Hoisting: Hoisting is a cryptographic optimization that further reduces the complexity of matrix-vector products. Hoisting can be applied to stages of the BSGS algorithm that share a common result. Rotations to the same input ciphertext share a common decompose output, so this computation can be performed only once, hoisting it out and reusing its result for all n₁ baby-step rotations.

The MDC-based kernels (204) can be configured to support a maximum ring degree N=2¹⁶ so the number of stages in each MDC can be s=16, and the width of each MDC can be p=256. The configuration can also accommodate the bandwidth characteristics of BSGS hoisting operation described in relation to FIGS. 4B and 4C.

Giant-Step Centric Data Flow. FIG. 4C shows a high-level overview of the double-hoisting algorithm using a matrix-vector product hardware accelerator to maximize the arithmetic intensity based on baby-step giant-step (BSGS) algorithm. Algorithm 2 shows an example execution (408) of the BSGS matrix-vector product algorithm. The BSGS algorithm can reduce the number of ciphertext rotations in a matrix-vector product with n non-zero diagonals from n to n₁+n₂, where n₁n₂=n. The GSC data flow (408) of FIG. 4C can additionally mask the latency when loading the baby-step rotation keys with diagonal generation using OTF-Limb (404). In FIG. 4C, three features of the GSC data flow (408) are noted.

First, rotations to the same input ciphertext can share a common decompose output (410), so the computation of the rotations can be performed only once, hoisting it out, and reusing its result for all n₁ baby-step rotations (412). A second level of hoisting can be performed when summing all giant steps 414. Bossuat et al. [9] had shown that the ModDown operation 416 can commute with addition per Equation 8. The decompose output 418 can be cached to leverage its reuse.

$${\sum }_{i} ModDown ( {ct}_{i} ) = ModDown ( {\sum }_{i} {ct}_{i} ) \qquad ( Eq . 8 )$$

Second, OTF-Limb (4040 can be used to generate the limbs of all plaintext matrix diagonals. Since each baby-step rotation key contributes to n₂ partial products, diagonals can be grouped into n₁ sets of n₂ diagonals to minimize off-chip memory accesses. While the interleaved pipelined inputs (e.g., MDC units (204, 206)) are generating the current set of n₂ matrix diagonals, the GSC dataflow (408) can load the next baby-step rotation key and use the Hadamard and Automorphism units (406a, 406b, and 407) to prepare the ciphertext's next baby-step rotation. If the latency of fetching a rotation key is less than the latency of generating n₂ plaintext diagonals, then the DRAM accesses can be completely overlapped.

Third, since each set of n₂ partial products are iteratively generated, the products (424) can be accumulated (426) to the reserved on-chip SRAM locations to reduce the size of the working set. When the ideal number of giant steps (414) exceeds what can be stored on-chip, the number of giant steps (414) in the BSGS algorithm can be reduced, rather than the partial products being sent off-chip. Since each giant step rotates a unique ciphertext, it cannot be hoisted out of the common decompose step. Consequently, giant steps (414) are more expensive than baby steps (412), and the optimal ratio of n₁/n₂ is large, often varying between 8 and 16 [9]. The maximum number of giant steps held on-chip can be set to n₂=4 in the highest multiplicative level matrix-vector products in bootstrapping.

Automorphisms. As noted above, automorphism can be used in the GSC matrix-vector operation, among other operations. Indeed, the exemplary systolic computing hardware can be configured to efficiently perform automorphisms, where the automorphism applies the index permutation ϕᵣ: i→i·5^{r} mod N to each limb of a polynomial in the evaluation representation and natural order. This index permutation can cyclically shift values in the underlying vector message by r slots to the left.

With ring degree N=2¹⁶, automorphism can be decomposed into 2⁸ smaller permutations of 2⁸ indices as described in [33]. To this end, more generally, any automorphism can be built from permutations to subsets of input indices if each subset S satisfies two conditions: |SI is a power of two, and the indices in S are evenly spaced by

$$\frac{N}{\vert S \vert} .$$

When |S|=N, the original automorphism can be recovered. The exemplary systolic computing hardware can leverage this property as the MDC units (e.g., 204, 206) can produce p=256 evenly spaced elements per cycle in natural order. Therefore, when an automorphism is required, the MDC's output can be passed to any p-to-p permutation network, completing the operation over N/p cycles. As an example, the permutations can be performed with a 256-to-256 Benes̆ network.

The Benes̆ network belongs to a family of multi-stage interconnection networks configured to simplify all-to-all communication. A p-to-p Benes network can comprise 2 log₂(p)−1 stages, each stage containing p/2 simple 2-input switches that collectively build arbitrary permutations over multiple stages. Fixed connections can link the stages together.

FIG. 4F shows an example 4-to-4 Benes̆ network performing ϕ₁ on the first limb of an interleaved polynomial in the natural order with N=16 and [symbol] =3. FIG. 4F illustrates three noted features. First, since input limbs are interleaved, elements from the same limb enter the network once every [symbol] +1=4 cycles. Second, subsets of p=4 indices, evenly spaced by N/p=4, enter the Benes̆ network per cycle. Since each subset meets the criteria above, any automorphism can be decomposed into local permutations of these subsets. Third, ϕ₁ permutes each element from index i to index i·5 1 mod 16. We highlight the path that maps index 3 to index 3·5¹ mod 16=15, alongside the full ϕ₁ automorphism.

Hadamard Unit and Key Generation. The exemplary systolic computing hardware can also include Hadamard units (e.g., 406a, 406b) configured for the point-wise multiplications and additions, e.g., in CKKS. The Hadamard units (406a, 406b) can also be used for point-wise multiplications with key-switching keys and plaintext polynomial diagonals. The Hadamard unit (406a, 406b) can constitute a set of p one-dimensional (ID) systolic arrays, each of height dnum. Each BConv cell (104′) can contain four modular multipliers and adders to support both KeyMult and diagonal multiplication simultaneously, preventing stalling in the data flow of the exemplary system. The exemplary systolic computing hardware can further include a pseudorandom-number-generation (PRNG) key generator (409). An example PRNG generator is described in CraterLake [46] and adopted in SHARP [32], which can generate half of all key-switching keys on-chip.

Comparison with Diagonal Method. FIG. 4D shows an example diagonal method to implement FHE matrix-vector products, where the number of non-zero diagonals, denoted as n, is 6. As shown, since the ciphertext is rotated n times, n distinct key-switch operations can be performed, each computing a Decompose, KeyMult, and ModDown to realign partial products under the same secret key. Thus, the runtime can be seen as O(n).

The diagonal method [27] is a naïve method to implement FHE matrix-vector products. In the diagonal method, a k^{th} generalized diagonal of a matrix M can first be extracted as diagₖ=M_{[0,k]}, M_{[1,1+k]}, . . . , M_{[w-1,w-1+k]}, where w is the width of the matrix, and the second index is taken modulo w. Each diagonal can be multiplied with a rotated input ciphertext. Specifically, a k^{th} diagonal, denoted as diagₖ, can be multiplied with the element in column k of M, rotating the input by k slots to align the plaintext diagonal and the ciphertext.

### Experimental Results and Additional Examples

A study was conducted to develop and evaluate the exemplary system and method having FHE operation implemented on a systolic hardware accelerator architecture. The systolic architectures having interleaved limb connected to a 2D systolic array can provide straightforward hardware implementation, clear compute-memory tradeoffs facilitating straightforward analytical analysis, and the elimination of complex hardware structures (e.g., register files). The study developed a prototype having interleaved limb and 2D systolic array accelerator and the giant-step centric dataflow for an FHE algorithm/scheme; the prototype was implemented with a significantly simpler FHE accelerator compared to prior work while achieving state-of-the-art bootstrap performance.

CPU Setup. The study evaluated the 2D interleaved limb and 2D systolic array accelerator using benchmarks executing along side the hardware on an r7g.16×large AWS instance with a Graviton3 processor clocked at 2.6 GHz and 512 GB of RAM. The study used the Orion FHE compiler [22] and Lattigo v5.2 to generate and evaluate the neural network benchmarks.

Modeling. Given the predictability of performance in the systolic arrays used by the exemplary system, the study developed an analytical performance model. First, the study tested the systolic design of each kernel with functional simulation to verify correctness. The study then outputted kernel traces from Lattigo running neural inferences to model the order of operations. The study mapped the kernels to corresponding units and timings for each used to estimate total runtime.

The goal in estimating power and area was to be commensurate with previous studies. To do this, the study normalized estimates to 7 nm. First, the study used the Montgomery multiplier and modular addition units from BTS [35], with area and power reported as 3833 μm², 325 μm², 1.35 mW, and 0.08 mW, respectively. The remaining components were synthesized using a commercial 28 nm library and scaled to 7 nm using scaling factors of 3.6 for area and 3.3 for power [19], [40], [53]. The study modeled power using Synopsys Design Compiler Version T-2022.03-SP2 [52] and assumed the worst-case switching to conservatively model data distribution in cryptographic workloads. Estimates of other logic (i.e., the crossbar, registers, MUXs, etc.) were synthesized, each using the library and scaling down as discussed above. The study further generated static random access memories (SRAMs) using a commercial SRAM compiler and estimated the area and power in 7 nm using the same scaling factors. The average SRAM density was 0.49 mm²/MB, similar to SHARP's [32]. The study had a total SRAM size of 256 MB for keys, partials, and decomposed polynomials; an additional 32 MB of space was needed for MDC buffering. Finally, the study made the same wire overhead assumption as in ARK [33], adding 10% area to the total design of the exemplary system. The study clocked the chip at 1 GHz.

The study evaluated the interleaved limb and 2D systolic array accelerator on a range of convolutional and fully-connected neural networks described in other studies [20], [21], [32], [33], [35], [36], [41], [46]. Table 2 shows the neural networks used as evaluation benchmarks in the study.

TABLE 2

| Benchmark | Description |
|---|---|
| Multi-layer | MLP is a three-layer fully connected network from |
| perceptron | SecureML [41] for MNIST. |
| (MLP) | |
| Local linear | LoLA is a three-layer convolutional neural network from |
| approximation | LoLA-CryptoNets [12] that also targets MNIST. |
| (LoLA) | LoLA was evaluated in CraterLake [46]. |
| LeNet | LeNet is a four-layer convolutional neural network |
| | adopted from Orion [22] and the CHET and EVA |
| | FHE compilers [20], [21]. LeNet comprises two |
| | strided convolutions and two fully connected layers. |
| Bootstrap | The state-of-the-art bootstrapping algorithm from Bossuat |
| | et al. [9] was used for evaluation in the study. |
| Residual | The study re-implemented the previous study [36], |
| network-20 | replacing convolutions with their analogous matrix-vector |
| (ResNet-20) | products and leaving everything else unchanged, |
| | including using high-degree composite polynomial |
| | approximations to Rectified Linear Unit (ReLU). |

The study also adopted the amortized multiplication time per slot metric (denoted as T_{mult, a/s}.) in [30] to develop a similar metric, denoted as amortized matrix-vector multiplication time per slot, defined in Equation 9, for a matrix with d non-zero diagonals. The metric is conceptually similar to T_{mult, a/s}, but it is aligned more closely with the order of operations found in neural networks.

$${T}_{M \times v : \# d , a / slot} = \frac{{T}_{boot} + {\sum }_{ℓ = 0}^{L - {L}_{boot}} {T}_{M \times v : \# d} ( ℓ )}{L - {L}_{boot}} \cdot \frac{2}{N} \qquad ( Eq . 9 )$$

Evaluation. The study evaluated the interleaved limb and 2D systolic array accelerator Osiris on the aforementioned benchmarks to confirm the many benefits afforded by systolic architectures in FHE. The study began by quantifying the implications of hoisting using the hardware acceleration. Then the study compared the interleaved limb and 2D systolic array accelerator against prior work. Next, the study performed a sensitivity study and demonstrated that balanced design from the interleaved limb and 2D systolic array accelerator enabled near linear scaling trends with compute and bandwidth. The study also conducted a roofline analysis [55] to show the effects of hoisting and neural architecture on utilization.

Benchmark Analysis. Table 2 shows the parameter sets used to evaluate the exemplary system. Moduli (qᵢ, pᵢ) and scales (Δ) are in bits.

Tables 4A and 4B each shows the latency of the benchmarks using the parameter sets from Table 3 on the exemplary interleaved limb and 2D systolic array accelerator with non-hoisted (NH), single-hoisted (SH), and double-hoisted (DH) BSGS matrix×vector algorithms. Table 4A shows the interleaved limb and 2D systolic array accelerator's improvements over the CPU implementations of Orion [22] at 1 TB/s. Table 4B further shows analysis from fully-packed bootstrapping and ResNet-20 at 2 TB/s.

TABLE 3

| Set | N | n | L | α | dnum | q⁰ | Δ/qⁱ | pⁱ | QP |
|---|---|---|---|---|---|---|---|---|---|
| I | 2¹⁴ | 2¹⁴ | 7 | 4 | 2 | 40 | 32 | 41 | 396 |
| II | 2¹⁴ | 2¹⁴ | 8 | 3 | 3 | 40 | 32 | 41 | 419 |
| II | 2¹⁵ | 2¹⁵ | 11 | 6 | 2 | 55 | 40 | 61 | 861 |
| IV | 2¹⁶ | 2¹⁵ | 23 | 8 | 3 | 55 | 40 | 61 | 1684 |

TABLE 4A

| Benchmark | Set | NH | SH | DH | CPU | | Improv. |
|---|---|---|---|---|---|---|---|
| T_{mult, a/s} (ns) | IV | 12.6 | 11.9 | 11.8 | 64 | μs | ×5420 |
| T_{Mν: 128, a/s} (ns) | IV | 26.6 | 25.6 | 20.9 | 98 | μs | ×4690 |
| MLP (ms) | I | 0.23 | 0.23 | 0.18 | 0.62 | s | ×3440 |
| LoLA (ms) | II | 0.83 | 0.83 | 0.75 | 1.29 | s | ×1720 |
| LeNet (ms) | III | 6.63 | 6.33 | 5.79 | 9.33 | s | ×1610 |
| Bootstrap (ms) | IV | 3.21 | 3.03 | 3.01 | 16.3 | s | ×5420 |
| ResNet-20 (ms) | IV | 139 | 134 | 125 | 620 | s | ×4960 |

TABLE 4B

| Benchmark | Set | NH | SH | DH | CPU | | Improv. |
|---|---|---|---|---|---|---|---|
| Bootstrap (ms) | IV | 3.21 | 2.84 | 2.09 | 16.3 | s | ×7800 |
| ResNet-20 (ms) | IV | 139 | 128 | 94.9 | 620 | s | ×6600 |

Two observations can be highlighted from the data in Tables 4A and 4B. First, hoisting appears to provide performance improvements despite lower arithmetic intensity. However, the benefits of hoisting were more pronounced at higher bandwidths since hoisting reduced arithmetic intensity. For example, double hoisting reduced the total modular multiplications in fully-packed bootstrapping on the exemplary system by 1.65× compared to BSGS without hoisting. However, at 1 TB/s, there was only a 1.07× improvement in latency. This discrepancy arose because the study could not mask the latency of loading baby-step rotation keys on-chip with the computations of on-the-fly limb extension in double hoisting. As such, the design stalled for 20.3% of its total execution time. Conversely, BSGS without hoisting was compute-limited; no further performance gains were achieved at higher bandwidths. At 2 TB/s, the stalls in double hoisting were reduced to just 0.04 ms, which led to a 1.56× improvement over BSGS without hoisting, approaching the theoretical limit.

Second, the study reported speed-ups ranging from 1610× to 5980× at 1 TB/s, with bootstrapping seeing the largest improvement. The higher multiplicative levels in bootstrapping entailed more work than operations at lower levels. The interleaved limb and 2D systolic array accelerator (and systolic architecture in general) appear to be well-suited for kernels with large and consistent data streams. The matrix-vector products in bootstrapping embodied this characteristic as they contained many sequential BConv and I/NTT operations. At the same time, the increased arithmetic intensity provided by on-the-fly limb extension was greatest when f was large, as more plaintext diagonals should be generated. Therefore, while the exemplary interleaved limb and 2D systolic array accelerator performed well across a spectrum of workloads, the exemplary hardware appears to excel in the most computationally intense scenarios. The growing complexity of FHE applications can be a promising trend for the exemplary interleaved limb and 2D systolic array accelerator.

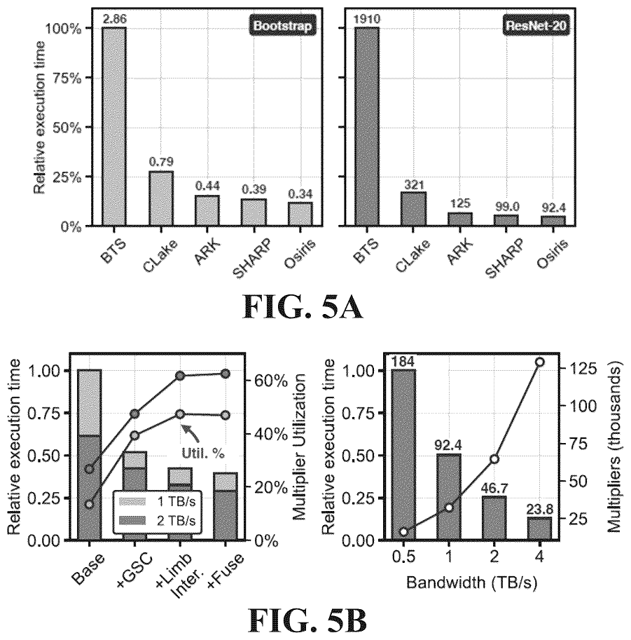

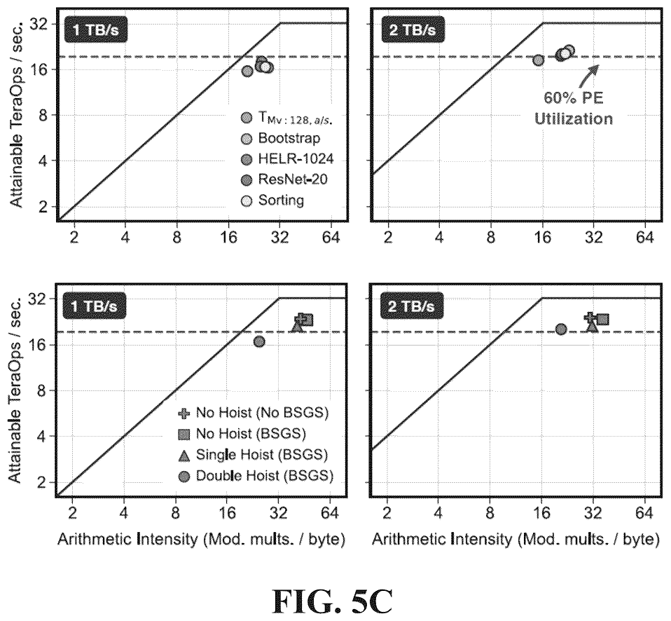

Latency. The study compared the exemplary interleaved limb and 2D systolic array accelerator's performance against the prior work of BTS [35], CraterLake [46], ARK [33], and SHARP [32]. FIG. 5A shows the latency of bootstrapping and ResNet-20 inference, as examples of two benchmarks common across the noted designs. To account for differences in parameter sets, the study normalized Bootstrap latency by L_{eff}. Three features can be observed in FIG. 5A.

First, the interleaved limb and 2D systolic array accelerator appears to achieve state-of-the-art fully packed Bootstrap performance at 1 TB/s (despite its aforementioned stalls). When compared at 2 TB/s, the interleaved limb and 2D systolic array accelerator appear to outperform SHARP by 1.4× (SHARP explicitly avoids hoisting in favor of the more arithmetically intense minimum key-switching strategy [32, 33]). Second, the study normalized latencies relative to BTS [35] as an example of a design that does not adopt the BSGS algorithm. To fairly compare with BTS, the study also implemented a bootstrapping variant that excludes both BSGS and hoisting. At 1 TB/s, the variant achieved the highest multiplier utilization of 80.7% and a Bootstrap latency of 6.87 ms, a 3.36× improvement over BTS when normalized by L_{eff}. Third, at 1 TB/s, the results do not match the ResNet-20 latency of SHARP [32], despite superior Bootstrap performance. SHARP uses 36-bit moduli, which can make it difficult to compare to the exemplary interleaved limb and 2D systolic array accelerator, which uses at most 64-bit moduli.

Power/area: Table 5 shows comparative of the interleaved limb and 2D systolic array accelerator against prior work. Similar to SHARP [32], the study used scaling factors for scaling from 14 nm to 7 nm area (2.8×) and power (2.2×) from [42] to fairly compare against CraterLake [46]. Notably, since the modular multiplier area and power appear to scale superlinearly with bit width [32], CraterLake and SHARP could achieve a higher total compute capability for a similar area and power budget. The study adopted the larger 64-bit modular multipliers from BTS [35] and ARK [33] and considered that the same principles of composite scaling [3] can also be applied to the exemplary interleaved limb and 2D systolic array accelerator.

TABLE 5

| ASIC | BW | Bit | Mod. | SRAM | Area | Power |
|---|---|---|---|---|---|---|
| design | (TB/s) | Width | Mults. | (MB) | (mm²) | (W) |
| BTS | 1 | 64 | 8192 | 512 | 373.6 | 163.2 |
| ARK | 1 | 64 | 19456 | 588 | 418.3 | 281.3 |
| SHARP | 1 | 36 | 35776 | 198 | 178.8 | 94.70 |
| CLake | 1 | 28 | 122000 | 256 | 222.7 | 169.7 |
| Osiris | 1 | 64 | 14080 | 288 | 305.0 | 143.6 |
| (exemplary | | | | | | |
| system) | | | | | | |

Sensitivity Study and Roofline Plots. In FIG. 5B, the study isolated the impacts of accelerator-specific algorithmic optimizations and the effects of scaling compute and bandwidth on ResNet-20 performance. FIG. 5B (left) shows starting with a baseline implementation of the interleaved limb and 2D systolic array accelerator at 1 TB/s without PRNG key generation (KeyGen) and on-the-fly limb extension (OTF-Limb) and subsequent implementations that incorporate both alongside 2× the SRAM (512 MB, excluding MDC buffers). By adopting both KeyGen and OTF-Limb, the study reduced the number of DRAM accesses for evaluation keys and plaintext diagonals by 3×, increasing multiplier utilization from 15% to 58%. In contrast, doubling SRAM capacity appears to have minimal impact on ResNet-20 performance since the GCS dataflow appears to sufficiently reduce the size of the working set. The ResNet-20 latency appears to be roughly halved with the doubling of both memory and computation. The near linear scaling trend appears to show the exemplary interleaved limb and 2D systolic array accelerator being a balanced design.

FIG. 5C shows roofline plots to illustrate the impact of hoisting and neural network architecture on the interleaved limb and 2D systolic array accelerator performance. Roofline plots offer an intuitive way to identify sources of performance bottlenecks and inform better algorithm and hardware design, particularly valuable in the context of FHE, where upwards of 100 GB of rotation keys may be streamed on-chip per ResNet-20 inference. The study defined arithmetic intensity to be the number of modular multiplications per byte of DRAM traffic; this metric has also been adopted by MAD [4]. In FIG. 5C, subpanel (a), the characteristics of the five neural network benchmarks at both 1 TB/sand 2 TB/s are shown. In FIG. 5C, subpanel (b), ResNet-20 and its implementation using the matrix-vector algorithms are shown.

Three features may be observed in FIG. 5C. First, the interleaved limb and 2D systolic array accelerator multiplier utilization appear to range from 55% to 77% and increase with bandwidth. The extent of the increase may be strongly correlated with the amount of hoisting performed. Second, arithmetic intensity appears to generally decrease with increasing bandwidth. The effect may occur because we independently optimize the ratio of baby-steps to giant-steps, n₁/n₂, at each bandwidth. At 2 TB/s, the optimal ratios may be higher, hoisting out more expensive operations and approaching the results derived in [9]. Third, the exemplary hardware appears to be well-balanced with the algorithms being situated near the roofline's ridge point. The outcome is likely due to the deliberate sizing of the interleaved limb and 2D systolic array accelerator width. The balanced design appears to enable the promising scaling trends seen in FIG. 5B (right).

### DISCUSSION

Cloud computing and online services have caused wide-scale data outsourcing, raising privacy and security concerns, which has sparked an increased interest in privacy-preserving computation and confidential computing techniques. These techniques facilitate evaluating functions directly on encrypted data, ensuring it is secured while off-device. One technique for cryptographic confidential computing is fully homomorphic encryption (FHE). FHE provides secure outsourced computation using emerging encryption schemes, making it a natural fit for today's cloud model. While promising, broad deployment of FHE remains limited due to the performance overhead it introduces.

Cryptographers have devised new FHE schemes and optimizations for better performance (e.g., SIMD ciphertext packing [50], hoisting [9], [28], and CKKS's native fixed-point support [14]). Compiler research has assuaged FHE's programming complexities while improving performance, including instruction scheduling [17], [38], [54], SIMD ciphertext packing and data layout [6], [22], [31], and bootstrap placement [2], [8]. Previous studies also developed architectures that provide the computational power needed to overcome the slowdown, spanning the architectural landscape. Solutions targeted fixed-function designs to demonstrate that the magnitudes of a slowdown can be overcome [44], [45]. Previous studies also developed vector architectures, a natural fit as the core data structure in FHE (rings) readily maps to the ISAs [24], [46], [51], and included tiled/clustered architectures and FPGAs. In tiled solutions, processing lanes and NoCs can be reformed to execute different FHE kernels [32], [33], [35]. FPGA-specific designs provide immediate speedup running on commercially available hardware [4], [5], [45], [49]. The reported speedup of previous studies is substantial, but there is still room for improvement. For example, fixed-function ASICs do not provide the flexibility to support a variety of FHE workloads or algorithms; vectors are flexible but rely on complex circuitry for generality and performance (e.g., register files and chaining); tiled/clustered may be challenging to program and require large NoCs.

The instant study developed the exemplary system (i.e., systolic architecture) to accelerate FHE, addressing the above-discussed problems. Rigid, lock-step communication eliminates the need for data sharing via register files (or chaining) and NoC wiring and minimizes control overhead. At the same time, data layout and staging flexibility provide the programmability to support a range of FHE parameters and workloads. The study recognized and distilled the complexity of FHE into a set of relatively simple computational cells with rigid communication patterns and devised a data flow that facilitated composing them into a complete systolic architecture.

The study developed individual systolic arrays for each FHE kernel (except for automorphism) in the exemplary system. The study also considered how kernels interacted and co-designed units with those they connected with to optimize interfaces. The number-theoretic transform (NTT) kernel worked over individual inputs (i.e., limbs). The basis conversion (BConv) kernel, which the study computed as a matrix multiply, demanded limb tiling and interspersing data from distinct limbs to be implemented using a large 2D systolic array. Naïve solutions may require large buffers between the units to reorganize data and introduce stalls. To address this issue, the study also developed an interleaved limb [1]. Interleaved limb tiles inputs take cross-sections of data from each limb as input sequentially, rather than processing each limb entirely one at a time. The blocked data can then flow directly through the NTT unit and into the BConv unit, eliminating large buffers and stalls. As each unit is systolic, the I/O rates were straightforward to balance. With interleaved limbs and the developed systolic units, the study developed the exemplary system (i.e., systolic architecture) configured to accelerate entire FHE workloads, including bootstrapping and inference.

The exemplary system can provide high-performance kernel accelerators and efficient interfaces between them, leaving flexibility in how FHE is mapped to it. Optimizing FHE data flow was complex and compounded by recent algorithmic advancements to computing matrix-vector products, specifically the baby-step giant-step (BSGS) algorithm [28] and double-hoisted rotations [9]. Double-hoisted rotations were a recent optimization that can reduce the absolute number of computations per key switch, a major FHE function. The results from computationally demanding kernels can be shared and reused, saving work recomputing them. This can cause two challenges: (i) masking data movement latency with fewer computations and (ii) deciding which data to cache on-chip. The study also developed the giant-step centric (GSC) data flow, which addressed both challenges. The exemplary system can support optimizations that reduce bandwidth, i.e., on-the-fly limb extension (OTF-Limb), key generation, and twiddle generation. In GCS, the study scheduled kernels such that OTF-Limb generation overlaps with off-chip (baby-step) key reads and sizes the exemplary system to balance their latencies. GSC caches partials on the chip, reusing rotated (baby-step) inputs. The GSC data flow, combined with the straightforward systolic architecture of the exemplary system, facilitates high performance and eases implementation.

Other designs. CPU/GPU: Multiple FHE software libraries are now available [1], [7], [15], [27], [48] that can provide high-performance CPU implementations. The high computational and memory bandwidth of GPUs provide a promising alternative to CPUs for running FHE. A collection of GPU implementations now exist. One of the first to port FHE to GPU was cuHE [18]. Kernel fusion was also proposed to offset limited on-chip memory in GPUs [30]. Others have fine-tuned specific kernels (e.g., NTT) for GPUs and achieved multiple orders of magnitude performance improvement [43].

FPGAs: Prior[5], [45], [56] employ FPGAs as lower-power, more custom alternative to GPUs, and further accelerates FHE. Notably, FAB [5] is the first to support CKKS bootstrapping on FPGAs and also employs the double-hoisting optimizations [9]. However, while FPGA-based approaches are significantly more flexible than ASIC designs, they still lack the available on-chip memory to scale compute without bandwidth concerns. The problems above motivate the need for ASIC acceleration. HEAX proposes an architecture for ciphertext-ciphertext multiplication and reports two orders of magnitude of speedup [45].

ASIC Acceleration: Fl [24] and Cheetah [44] were among the first ASIC designs to target homomorphic encryption. Since then, many works such as CraterLake [46], BTS [35], ARK [33], and SHARP [32] have targeted fully homomorphic encryption, explicitly supporting bootstrapping. CraterLake [46] was the first to realize sub-second ResNet-20 latencies, and optimizations such as minimum key-switching and on-the-fly limb-extension from ARK [33] and SHARP [32] have further reduced latencies by 3×. Moreover, the use of 36-bit moduli in SHARP [32], coupled with PRNG key generation from CraterLake [46], have pushed FHE into the realm of practicality, tackling critical issues such as prohibitively large on-chip memories and low arithmetic intensity.

Further description and examples are provided in Ebel, Austin, and Brandon Reagen. “Osiris: A Systolic Approach to Accelerating Fully Homomorphic Encryption.” arXiv preprint arXiv:2408.09593 (2024), which is incorporated by reference herein in its entirety.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using in part computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] Lattigo v4. Online: https://github.com/tuneinsight/lattigo, August 2022. EPFL-LDS, Tune Insight SA.
[2] DaCapo: Automatic bootstrapping management for efficient fully homomorphic encryption. In 33rd USENIX Security Symposium (USENIX Security 24), Philadelphia, PA, August 2024. USENIX Association.
[3] Rashmi Agrawal, et al. High-precision rns-ckks on fixed but smaller word-size architectures: theory and application. In Proceedings of the 11th Workshop on Encrypted Computing & Applied Homomorphic Cryptography, WAHC '23, page 23-34, New York, NY, USA, 2023. Association for Computing Machinery.
[4] Rashmi Agrawal, et al. Mad: Memory-aware design techniques for accelerating fully homomorphic encryption. In MICRO, 2023.
[5] Rashmi Agrawal, Leo de Castro, Guowei Yang, Chiraag Juvekar, Rabia Yazicigil, Anantha Chandrakasan, Vinod Vaikuntanathan, and Ajay Joshi. Fab: An fpga-based accelerator for bootstrappable fully homomorphic encryption, 2022.
[6] Ehud Aharoni, et al. HeLayers: A tile tensors framework for large neural networks on encrypted data. Proceedings on Privacy Enhancing Technologies, 2023(1):325-342, jan 2023.
[7] Ahmad Al Badawi, et al. Openfhe: Open-source fully homomorphic encryption library. Cryptology ePrint Archive, Paper 2022/915, 2022. https://eprint.iacr.org/2022/915.
[8] Fabrice Benhamouda, Tancrede Lepoint, Claire Mathieu, and Hang Zhou. Optimization of bootstrapping in circuits, 2016.
[9] Jean-Philippe Bossuat, et al. Efficient bootstrapping for approximate homomorphic encryption with non-sparse keys. Cryptology ePrint Archive, Paper 2020/1203, 2020. https://eprint.iacr.org/2020/1203.
[10] Zvika Brakerski, Craig Gentry, and Vinod Vaikuntanathan. (leveled) fully homomorphic encryption without bootstrapping. ACM Transactions on Computation Theory (TOCT), 6(3):1-36, 2014.
[11] Zvika Brakerski and Vinod Vaikuntanathan. Fully homomorphic encryption from ring-lwe and security for key dependent messages. In Annual cryptology conference, pages 505-524. Springer, 2011.
[12] Alon Brutzkus, Oren Elisha, and Ran Gilad-Bachrach. Low latency privacy preserving inference. In International Conference on Machine Learning, 2019.
[13] Jung Hee Cheon, et al. A full rns variant of approximate homomorphic encryption. In Selected Areas in Cryptography—SAC 2018: 25th International Conference, Calgary, AB, Canada, Aug. 15-17, 2018, Revised Selected Papers 25, pages 347-368. Springer, 2019.
[14] Jung Hee Cheon, et al. Homomorphic encryption for arithmetic of approximate numbers. In International conference on the theory and application of cryptology and information security, pages 409-437. Springer, 2017.
[15] Jung Hee Cheon, et al. Homomorphic encryption for arithmetic of approximate numbers. In Tsuyoshi Takagi and Thomas Peyrin, editors, Advances in Cryptology—ASIACRYPT 2017, pages 409-437, Cham, 2017. Springer International Publishing.
[16] James W. Cooley and John W. Tukey. An algorithm for the machine calculation of complex fourier series. Mathematics of Computation, 19(90):297-301, 1965.
[17] Meghan Cowan, et al. Porcupine: A synthesizing compiler for vectorized homomorphic encryption. In Proceedings of the 42nd ACM SIGPLAN International Conference on Programming Language Design and Implementation, PLDI 2021, page 375-389, New York, NY, USA, 2021. Association for Computing Machinery.
[18] Wei Dai. cuHE: CUDA homomorphic encryption library.
[19] Nanotechnology Products Database. Tsmc 16ff+ (finfet plus). 2023.
[20] Roshan Dathathri, et al. EVA: an encrypted vector arithmetic language and compiler for efficient homomorphic computation. In Proceedings of the 41st ACM SIGPLAN Conference on Programming Language Design and Implementation. ACM, jun 2020.
[21] Roshan Dathathri, et al. Chet: An optimizing compiler for fully-homomorphic neural-network inferencing. In Proceedings of the 40th ACM SIGPLAN Conference on Programming Language Design and Implementation, PLDI 2019, page 142-156, New York, NY, USA, 2019. Association for Computing Machinery.
[22] Austin Ebel, et al. Orion: A fully homomorphic encryption compiler for private deep neural network inference, 2023.
[23] Junfeng Fan and Frederik Vercauteren. Somewhat practical fully homomorphic encryption. Cryptology ePrint Archive, 2012.
[24] Axel Feldmann, et al. F1: A fast and programmable accelerator for fully homomorphic encryption (extended version), 2021.
[25] Franz Franchetti and Markus Puschel. FFT (Fast Fourier Transform), pages 658-671. 2011.
[26] Mario Garrido. A survey on pipelined fft hardware architectures. Journal of Signal Processing Systems, 94(11):1345-1364, 2022.
[27] Shai Halevi and Victor Shoup. Algorithms in helib. Cryptology ePrint Archive, Paper 2014/106, 2014. https://eprint.iacr.org/2014/106.
[28] Shai Halevi and Victor Shoup. Faster homomorphic linear transformations in helib. In Hovav Shacham and Alexandra Boldyreva, editors, Advances in Cryptology—CRYPTO 2018, pages 93-120, Cham, 2018. Springer International Publishing.
[29] Kyoohyung Han and Dohyeong Ki. Better bootstrapping for approximate homomorphic encryption. In Cryptographers' Track at the RSA Conference, pages 364-390. Springer, 2020.
[30] Wonkyung Jung, et al. Over 100× faster bootstrapping in fully homomorphic encryption through memory-centric optimization with gpus. IACR Transactions on Cryptographic Hardware and Embedded Systems, 2021(4):114-148, August 2021.
[31] Chiraag Juvekar, Vinod Vaikuntanathan, and Anantha Chandrakasan. Gazelle: A low latency framework for secure neural network inference. In Proceedings of the 27th USENIX Conference on Security Symposium, SEC'18, page 1651-1668, USA, 2018. USENIX Association.
[32] Jongmin Kim et al. Sharp: A short-word hierarchical accelerator for robust and practical fully homomorphic encryption. In Proceedings of the 50th Annual International Symposium on Computer Architecture, ISCA '23, New York, NY, USA, 2023. Association for Computing Machinery.
[33] Jongmin Kim, et al. ARK: Fully homomorphic encryption accelerator with runtime data generation and inter-operation key reuse. In 2022 55th IEEE/ACM International Symposium on Microarchitecture (MICRO). IEEE, oct 2022.
[34] Sangpyo Kim, et al. Accelerating number theoretic transformations for bootstrappable homomorphic encryption on gpus. In 2020 IEEE International Symposium on Workload Characterization (IISWC). IEEE, October 2020.
[35] Sangpyo Kim, et al. BTS. In Proceedings of the 49th Annual International Symposium on Computer Architecture. ACM, jun 2022.
[36] Eunsang Lee, et al. Low-complexity deep convolutional neural networks on fully homomorphic encryption using multiplexed parallel convolutions. In Kamalika Chaudhuri, Stefanie Jegelka, Le Song, Csaba Szepesvari, Gang Niu, and Sivan Sabato, editors, Proceedings of the 39th International Conference on Machine Learning, volume 162 of Proceedings of Machine Learning Research, pages 12403-12422. PMLR, 17-23 Jul. 2022.
[37] Thomas Lenart and Viktor Owall. Architectures for dynamic data scaling in 2/4/8 k pipeline fft cores. IEEE Transactions on Very Large Scale Integration (VLSI) Systems, 14(11):1286-1290, 2006.
[38] Raghav Malik, et al.: A compiler for vectorizing encrypted arithmetic circuits. In Proceedings of the 28th ACM International Conference on Architectural Support for Programming Languages and Operating Systems, Volume 3, ASPLOS 2023, page 118-133, New York, NY, USA, 2023. Association for Computing Machinery.
[39]J. H. McClellan and R. J. Purdy. Applications of digital signal processing to radar, chapter 5. Prentice-Hall, Englewood Cliffs, NJ, 1978.
[40] Jiangiao Mo, et al. Haac: A hardware-software co-design to accelerate garbled circuits. In Proceedings of the 50th Annual International Symposium on Computer Architecture, ISCA '23. ACM, June 2023.
[41] Payman Mohassel and Yupeng Zhang. Secureml: A system for scalable privacy-preserving machine learning. Cryptology ePrint Archive, Paper 2017/396, 2017. https://eprint.iacr.org/2017/396.
[42]S. Narasimha et al. A 7 nm cmos technology platform for mobile and high performance compute application. In 2017 IEEE International Electron Devices Meeting (IEDM), pages 29.5.1-29.5.4, 2017.
[43] Ozgun Ozerk, Can Elgezen, Ahmet Can Mert, Erdinc Ozturk, and Erkay Savas. Efficient number theoretic transform implementation on gpu for homomorphic encryption. Cryptology ePrint Archive, Paper 2021/124, 2021. https://eprint.iacr.org/2021/124.
[44] Brandon Reagen, Wooseok Choi, Yeongil Ko, Vincent Lee, Gu-Yeon Wei, Hsien-Hsin S. Lee, and David Brooks. Cheetah: Optimizing and accelerating homomorphic encryption for private inference, 2020.
[45]M. Sadegh Riazi, Kim Laine, Blake Pelton, and Wei Dai. Heax: An architecture for computing on encrypted data. In Proceedings of the TwentyFifth International Conference on Architectural Support for Programming Languages and Operating Systems, ASPLOS '20, page 1295-1309, New York, NY, USA, 2020. Association for Computing Machinery.
[46] Nikola Samardzic, et al. Craterlake: A hardware accelerator for efficient unbounded computation on encrypted data. In Proceedings of the 49th Annual International Symposium on Computer Architecture, ISCA '22, page 173-187, New York, NY, USA, 2022. Association for Computing Machinery.
[47] Miguel A. Sanchez, t al. Implementing fft-based digital channelized receivers on fpga platforms. IEEE Transactions on Aerospace and Electronic Systems, 44(4):1567-1585, 2008.
[48] Microsoft SEAL (release 4.1). https://github.com/Microsoft/SEAL, January 2023. Microsoft Research, Redmond, WA.
[49] Sujoy Sinha Roy, Furkan Turan, Kimmo Jarvinen, Frederik Vercauteren, and Ingrid Verbauwhede. Fpga-based high-performance parallel architecture for homomorphic computing on encrypted data. In 2019 IEEE International Symposium on High Performance Computer Architecture (HPCA), pages 387-398, 2019.
[50]N. P. Smart and F. Vercauteren. Fully homomorphic simd operations. Des. Codes Cryptography, 71(1):57-81, apr 2014.
[51] Deepraj Soni, et al. RPU: the ring processing unit. In IEEE International Symposium on Performance Analysis of Systems and Software, ISPASS 2023, Raleigh, NC, USA, Apr. 23-25, 2023, pages 272-282. IEEE, 2023.
[52] Synopsys. Synopsys synthesis installation notes version t-2022.03 (march 2022), March 2022.
[53] TSMC. 16/12 nm technology.
[54] Alexander Viand, Patrick Jattke, Miro Haller, and Anwar Hithnawi. Heco: Fully homomorphic encryption compiler, 2023.
[55] Samuel Williams, Andrew Waterman, and David Patterson. Roofline: an insightful visual performance model for multicore architectures. Communications of the ACM, 52(4):65-76, 2009.
[56] Yinghao Yang, Huaizhi Zhang, Shengyu Fan, Hang Lu, Mingzhe Zhang, and Xiaowei Li. Poseidon: Practical homomorphic encryption accelerator. In 2023 IEEE International Symposium on High-Performance Computer Architecture (HPCA), pages 870-881, 2023.
[57] Ebel, Austin, and Brandon Reagen. “Osiris: A Systolic Approach to Accelerating Fully Homomorphic Encryption.” arXiv preprint arXiv:2408.09593 (2024).

What is claimed:

1. A processor comprising:
a 2D systolic array circuit configured to perform a homomorphic encryption kernel operation, the 2D systolic array circuit comprising:
an array of n×m processing elements (PEs), a subset of which are the same as one another, wherein processing elements of the array of n×m processing elements are configured to run in lock-step to one another and at least one connected first input limb and second input limb;
a first set of interleaved pipelined input, as the first input limb, coupled to the array of n×m processing elements at a first set of inputs to the array; and
a second set of interleaved pipelined input, as the second input limb, coupled to the array of n×m processing elements at a second set of inputs to the array;
wherein data corresponding to mathematical elements of a mathematical equation to perform the homomorphic encryption kernel operation are directed through the first set of interleaved pipelined input in an interleaved and lock-step manner for computation by the processing elements of the array and limbs in lockstep execution for the homomorphic encryption kernel operation.

2. The processor of claim 1, wherein the 2D systolic array circuit is configured to perform, at least, matrix-matrix multiplication, the array of n×m processing elements of the 2D systolic array circuit, as an array of cells, includes a first row of cells configured to receive, as a sequence of first inputs, the first set of interleaved limbs (L₁, L₂, . . . , Lₙ), each of which is represented by a corresponding set of coefficients and each of which is associated with a modulus (q₁, q₂, . . . , qₙ), wherein the first set of interleaved limbs (L₁, L₂, . . . , Lₙ) is derived from a first polynomial representing a first value at a first modulus, and wherein the array of cells includes a first column of cells configured to receive, as a sequence of second inputs, base table constants.

3. The processor of claim 1, wherein the first set of interleaved pipelined input is configured to perform interleaved Inverse Number Theoretic Transform(INTT) operations.

4. The processor of claim 1, wherein the 2D systolic array circuit includes a set of interleaved pipelined output, as the first output limb, wherein the first set of interleaved pipelined output is configured to perform Number Theoretic Transform (NTT) operations.

5. The processor of claim 1, wherein the first set of interleaved pipelined input comprises a plurality of multi-delay elements arranged in parallel configuration having s stages and p parallel inputs.

6. The processor of claim 1, wherein the interleaved pipelined hardware input can be reconfigured to operate as an interleaved pipelined hardware output for a subset of the processing.

7. The processor of claim 1, further comprising an automorphism unit having inputs coupled with outputs of an interleaved pipelined output.

8. The processor of claim 1, further comprising
a first Hadamard unit coupled to the first set of interleaved pipelined input.

9. The circuit of claim 1, further comprising
a second Hadamard unit coupled to the first set of interleaved pipelined output.

10. The processor of claim 1, wherein the lockstep execution includes, at least, operation of the array of n×m processing elements, the first set of interleaved pipelined input, and the second set of interleaved pipelined input under a common clock signal.

11. The processor of claim 1, wherein each cell of the array is configured to perform a switch-modulus multiply-accumulate operation

12. The processor of claim 1 further comprising:
a controller configured to write the mathematical elements of the mathematical equation to perform the homomorphic encryption kernel operation to memory, the memory being operatively accessible to the first set of interleaved pipelined input and the second set of interleaved pipelined input.

13. The processor of claim 1 further comprising:
a controller configured to perform a giant-step centric (GSC) dataflow operator to perform an FHE operation.

14. The processor of claim 1, wherein the homomorphic encryption kernel operation includes at least one of: CKKS, BGV, BFV, addition and/or multiplications of two ciphertexts, additions and/or multiplications of a ciphertext and a plaintext polynomial, rotation of a cleartext and/or ciphertext.

15. A method comprising:
performing a homomorphic encryption kernel operation using a 2D systolic array circuit comprising:
an array of n×m processing elements (PEs), a subset of which are the same as one another, wherein processing elements of the array of n×m processing elements are configured to run in lock-step to one another and at least one connected first input limb and second input limb;
a first set of interleaved pipelined input, as the first input limb, coupled to the array of n×m processing elements at a first set of inputs to the array; and
a second set of interleaved pipelined input, as the second input limb, coupled to the array of n×m processing elements at a second set of inputs to the array; and
directing data through the first set of interleaved pipelined input in an interleaved and lock-step manner for computation by the processing elements of the array and limbs in lockstep execution for the homomorphic encryption kernel operation.

16. The method of claim 15, wherein the 2D systolic array circuit is configured to perform, at least, matrix-matrix multiplication, the array of n×m processing elements of the 2D systolic array circuit, as an array of cells, includes a first row of cells configured to receive, as a sequence of first inputs, the first set of interleaved limbs (L₁, L₂, . . . , Lₙ), each of which is represented by a corresponding set of coefficients and each of which is associated with a modulus (q₁, q₂, . . . , qₙ), wherein the first set of interleaved limbs (L₁, L₂, . . . , Lₙ) is derived from a first polynomial representing a first value at a first modulus, and wherein the array of cells includes a first column of cells configured to receive, as a sequence of second inputs, base table constants.

17. The method of claim 15, wherein the first set of interleaved pipelined input is configured to perform interleaved Inverse Number Theoretic Transform(INTT) operations, wherein the 2D systolic array circuit includes a set of interleaved pipelined output, as the first output limb, wherein the first set of interleaved pipelined output is configured to perform Number Theoretic Transform (NTT) operations.

18. The method of claim 1 further comprising:
reconfiguring the first set of interleaved pipelined input to operate as an interleaved pipelined hardware output for a subset of the processing.

19. The method of claim 1 further comprising:
writing the mathematical elements of the mathematical equation to perform the homomorphic encryption kernel operation to memory, the memory being operatively accessible to the first set of interleaved pipelined input and the second set of interleaved pipelined input.

20. A non-transitory computer-readable method comprising instructions that, when executed by a host processor or logic circuit, causes the host processor or logic circuit to:
receive an encrypted message;
provide the encrypted message to the processor to perform a HE or FHE operation to the encrypted message, wherein the processor comprises:
a 2D systolic array circuit configured to perform a homomorphic encryption kernel operation, the 2D systolic array circuit comprising:
an array of n×m processing elements (PEs), a subset of which are the same as one another, wherein processing elements of the array of n×m processing elements are configured to run in lock-step to one another and at least one connected first input limb and second input limb;
a first set of interleaved pipelined input, as the first input limb, coupled to the array of n×m processing elements at a first set of inputs to the array; and
a second set of interleaved pipelined input, as the second input limb, coupled to the array of n×m processing elements at a second set of inputs to the array;
wherein data corresponding to mathematical elements of a mathematical equation to perform the homomorphic encryption kernel operation are directed through the first set of interleaved pipelined input in an interleaved and lock-step manner for computation by the processing elements of the array and limbs in lockstep execution for the homomorphic encryption kernel operation.
